(19) United States
(12) Patent Application Publication
(10) Pub. No.: US 2026/0035525 A1
(43) Pub. Date: Feb. 5, 2026

(54) Silicone Foams Prepared Using Non-Fluorinated Blowing Agents

(71) Applicant: Henry Company, LLC, Kimberton, PA (US)

(72) Inventors: Alex Ionkin, Kennett Square, PA (US); Divya Chopra, West Chester, PA (US)

(21) Appl. No.: 19/287,355

(22) Filed: Jul. 31, 2025

Related U.S. Application Data
(60) Provisional application No. 63/678,374, filed on Aug. 1, 2024.

(51) Int. Cl. C08J 9/08; C08J 9/14

(52) U.S. Cl. CPC C08J 9/08; C08J 9/141; C08J 9/142; C08J 9/146; C08J 2201/022; C08J 2201/024; C08J 2201/026; C08J 2203/02; C08J 2203/12; C08J 2203/16; C08J 2205/044; C08J 2205/048; C08J 2207/04; C08J 2383/04

(57) ABSTRACT

Disclosed herein are new types of foam insulation, and in particular, foam insulation for the exterior surfaces of residential, industrial, institutional or commercial buildings made using new silicone spray foam systems. These inventions relate to isocyanate-free foams used for thermal insulation, flame-retardancy and water resistance. The foams are prepared from silicone polymers with non-fluorinated blowing agents and can be used in the construction industry.

### FIELD OF THE INVENTION

The disclosed inventions are in the field of insulation, particularly in field of insulating exterior surfaces of residential, industrial, institutional or commercial buildings. The disclosed inventions are also in the field of silicone spray foam systems.

### BACKGROUND OF THE INVENTION

In the construction of most buildings, and in particular, in residential housing applications, walls are constructed using structural lumber, such as 2×4, or 2×6 wood studs, to which an external sheathing of a wood or wood composite panel is applied. By insulating the cavities created in the stud walls using, for example, fiberglass batt insulation, R-values of between 10 and 20 can be obtained. Fiberglass batts, however, can allow air leakage around the batts (if not properly installed), and provide little resistance to air, water vapor or water permeability. As a result, the use of an air, water, and water vapor barrier on the interior of the building is required. This prevents moist air from contacting the cool exterior wall, and creating condensation within the wall cavity.

The use of polyurethane foam has become more common in building construction applications. In these systems, the stud wall cavities are filled with a liquid spray foam material which expands to fill the wall cavity, or the material is applied to the outside of the wall. Compared to fiberglass batt insulation, these spray foam materials are generally superior at filling the voids in the wall cavity, and thus, they generally reduce the possibility of air leakages within the wall.

These types of products are generally applied on-site, and are the foamed reaction products of an isocyanate and a polyol which are reacted together to create the foamed product. Generally, the closed cell spray foamed material is applied using a hydrofluorocarbon (HFC) blowing agent so as to create a medium density closed cell material having a foam density of about 2 lb. per cubic foot and an R-value of 5 to 6.5 per inch. When a thickness of 2 inches or more is installed, this material typically acts as both a vapor barrier and an air barrier, and thus can prevent moisture from the interior of the building from reaching the cool exterior walls.

However, with the establishment and continued evolution of the Montreal Protocol, foam blowing agents (FBAs) used for closed-cell polymeric foam products have changed dramatically over the last two decades. Beginning in 1989, both thermoset and thermoplastic foam industries worldwide moved away from chlorofluorocarbons (CFCs) in favor of hydrochlorofluorocarbons (HCFCs), such as HCFC-141b and 142b. These alternatives were chosen as they provided a greatly decreased ozone depletion potential (ODP). Today, countries have either eliminated the use of, or are in the process of phasing out, HCFCs in foam applications, in order to meet the amended Montreal Protocol's regulated goal of zero ODP foam blowing agents. This has led to the widespread use of third-generation zero ODP hydrofluorocarbon (HFC) foam blowing agents, such as HFC-245fa, HFC-365mfc, and HFC-134a. However, maturing environmental awareness has put even such HFCs under speculation and, according to the amended Montreal Protocol, will not be suitable for use (based on application and country), due to their moderate global warming potential (GWP). As a result, many countries and polymeric foam manufacturers find themselves in need of a zero ODP and low GWP foam expansion agent.

While polyurethane foam and its manufacture may address some of the above issues, spray polyurethane foam is created by mixing polyol resin and isocyanate in the spray nozzle in 2-component systems and moisture-cured in case of aerosol 1 component systems. However, the polyurethane foam product faces regulation changes that restrict the use of toxic isocyanates, with its supply also a problem. Impending changes in governmental regulations imply adjusted safety labelling, disposal as hazardous waste, and a lowering of the free monomeric content below 1% w/w, all of which are key drivers for industrial manufacturers to develop isocyanate-free PU foam products. In addition, PU foams require complex spray rigs, full PPE, and limited public traffic for application in construction jobs. This adds to the job set-up cost and interruption to the business.

On the other hand, silicone foam does not require an isocyanate for its making. Starting ingredients for the silicone foams are environmentally friendlier than ones for polyurethane foams. Polyurethane foams typically require applying fluorinated blowing agents to preserve starting isocyanates used as a source of CO₂ for the foaming process.

Consequently, there is a need to replace polyurethane foam with more compliant and environmentally friendly foam materials in home building envelope industry, which do not require fluorinated blowing agents during forming process. The disclosed inventions are directed to these and other important needs.

### SUMMARY OF THE INVENTION

The disclosed inventions relate to isocyanate-free foams used for thermal insulation, flame-retardancy and water resistance. The foams can be prepared from silicone polymers with non-fluorinated blowing agents. In one embodiment, the blowing agent is methylal. Preferably, the foams are used in the construction industry.

In one embodiment, an open-cell, close cell, and hybrid-cell silicone foam is provided that has a controllable cell size and structure, which allows the foam to act as an air and water barrier while still having acceptable water vapor permeability. The foam preferably is produced using methylal as a blowing agent, and optionally can also include a mixture of open cell-promoting, and closed-cell-promoting surfactants so as to provide an open cell foam structure having a desired cell size. In one embodiment, the foams of the present invention are suitable for use as insulation on the exterior surfaces of a building.

In one embodiment, this invention relates to a pre-foam mix comprising:
(i) at least one foamable silicone pre-polymer; and
(ii) one blowing agent comprising at least one non-fluorinated blowing agent.

In another embodiment, this invention relates to a foam as described above, comprising at least one partially-cured silicone polymer and at least one non-fluorinated blowing agent.

In yet another embodiment, this invention relates to a foam as described above, comprising at least one partially-cured silicone polymer, wherein said foam is prepared using at least one non-fluorinated blowing agent.

In one embodiment, this invention relates to a foam as described above, comprising at least one substantially-cured silicone polymer and at least one non-fluorinated blowing agent.

In another embodiment, this invention relates to a foam as described above, comprising at least one substantially-cured silicone polymer, wherein said foam is prepared using at least one non-fluorinated blowing agent.

In yet another embodiment, this invention relates to a pre-foam or foam as recited above, wherein said non-fluorinated blowing agent is selected from methylal, ethylal, propylal, butylal, tetraoxaundecane, 1,3-dioxolane, 2-ethylhexylal, glycerol formal, dimethyl acetal, fructone, water, methyl formate, unsymmetrical methyl ethyl acetal of formaldehyde, cyclopentane, n-pentane, isopentane, blends thereof, mixtures thereof, and combinations thereof.

In one embodiment, this invention relates to the pre-foam or foam as recited above, wherein, the non-fluorinated blowing agent further comprises a polyol such as a diol or a triol or tetrol.

In another embodiment, this invention relates to the pre-foam or foam as recited above, wherein said blowing agent comprises at least one fluorinated blowing agent selected from HFO-1233-zd-E, HFC-245fa, HFC-365mfc, HFO-1336 mzz-Z, HFC-227ea, blends thereof, mixtures thereof, and combinations thereof.

In yet another embodiment, this invention relates to the pre-foam or foam as recited above, wherein said foam is substantially close-celled.

In one embodiment, this invention relates to the pre-foam or foam as recited above, wherein said foam is substantially open-celled.

In another embodiment, this invention relates to the pre-foam or foam as recited above, wherein said foam is partially open-celled and partially close-celled.

In yet another embodiment, this invention relates to the pre-foam or foam as recited above, wherein said non-fluorinated blowing agent is used in the concentration ranging from 0.1% to about 20% by weight of the blowing agent over the total weight of the pre-foam mix as recited in claim 1.

In one embodiment, this invention relates to the pre-foam or foam as recited above, wherein said at least one silicone pre-polymer or said at least one silicone polymer with Si—O—Si— backbone and organic methyl or phenyl groups attached to the silicon atoms (Me-Si or Ph-Si).

In another embodiment, this invention relates to the pre-foam or foam as recited above, further comprising a foaming agent.

In yet another embodiment, this invention relates to a process for preparing a foam comprising at least one foamable silicone polymer, said process comprising the steps of:
providing at least one silicone pre-polymer;
providing at least one non-fluorinated blowing agent;
optionally mixing more than one silicone pre-polymers;
removing said at least one non-fluorinated blowing agent;
partially or substantially fully curing said at least one silicone pre-polymer or said product of mixing more than one silicone pre-polymers.

In one embodiment, this invention relates to a foam comprising at least one partially-cured silicone polymer and at least one non-fluorinated blowing agent prepared by the process as recited above.

In another embodiment, this invention relates to a foam comprising at least one substantially-cured silicone polymer and at least one non-fluorinated blowing agent, as recited above.

In yet another embodiment, this invention relates to a process or foam as recited above, wherein said non-fluorinated blowing agent is selected from methylal, ethylal, propylal, butylal, tetraoxaundecane, 1,3-dioxolane, 2-ethylhexylal, glycerol formal, unsymmetrical methyl ethyl acetal of formaldehyde, dimethyl acetal, fructone, water, methyl formate, cyclopentane, n-pentane, isopentane, blends thereof, mixtures thereof, and combinations thereof.

In one embodiment, this invention relates to a process or foam as recited above, wherein the non-fluorinated blowing agent further comprises a polyol such as a diol or a triol or tetrol.

In another embodiment, this invention relates to a process or foam as recited above, wherein said blowing agent comprises at least one fluorinated blowing agent selected from HFO-1233-zd-E, HFC-245fa, HFC-365mfc, HFO-1336 mzz-Z, HFC-227ea, blends thereof, mixtures thereof, and combinations thereof.

In yet another embodiment, this invention relates to a process or foam as recited above, wherein said foam is substantially close-celled.

In one embodiment, this invention relates to a process or foam as recited above, wherein said foam is substantially open-celled.

In another embodiment, this invention relates to a process or foam as recited above, wherein said foam is substantially close-celled and substantially open-celled, or hybrid.

In yet another embodiment, this invention relates to a process or foam as recited above, wherein, said non-fluorinated blowing agent is used in the concentration ranging from 0.1% to about 20% by weight of the blowing agent over the total weight of the pre-foam mix as recited above.

In one embodiment, this invention relates to a process or foam as recited above, wherein said at least one silicone pre-polymer or said at least one silicone polymer with Si—O—Si— backbone and organic methyl or phenyl groups attached to the silicon atoms (Me-Si or Ph-Si).

In another embodiment, this invention relates to a process a pre-foam mix, or a foam as recited in claims above further comprising a foaming agent.

In yet another embodiment, this invention relates to a method for insulating the exterior surface of a building comprising spraying the exterior surface of the building with a mixture of silicone pre-polymer and a blowing agent, to produce a silicone foam, wherein said silicone foam is prepared by curing the silicone pre-polymer, and optionally at least one surfactant, wherein said silicone foam has an open-cell structure, a close-cell structure, or a hybrid-structure, and wherein said open cell structure comprises cells which are essentially open, but also includes some randomly occurring, solid cell walls.

In one embodiment, this invention relates to a method as recited above, wherein said silicone foam has a foam density of between 50 and 350 kg/m³, and has a cell size of between 0.03 μm and 1.5 μm, so that said silicone foam acts as a water and air barrier, while also being water vapor permeable.

In another embodiment, this invention relates to a method as recited above, wherein said polyurethane foam is prepared by reacting a mixture of said A Component with said B Component at a weight ratio of from 0.5 to 5:1, wherein Component A is one type of silicone pre-polymer and Component B is another type of silicone pre-polymer.

In yet another embodiment, this invention relates to a method as recited above, wherein said surfactant is a mixture of an open-cell promoting surfactant and a closed-cell promoting surfactant.

In one embodiment, this invention relates to a method as recited above, wherein said silicone foam is formed by a combination of surfactants that results in a surfactant interaction which produces both completely open and at least partially open, cell walls.

In another embodiment, this invention relates to a method as recited above, wherein the open cell content of the silicone foams is greater than 95%, by number.

In yet another embodiment, this invention relates to a method as recited above, wherein said B Component additionally comprises a flame retardant.

In one embodiment, this invention relates to a method as recited above, wherein said open cells have a cell size of between 0.1 μm and 1.0 μm.

In another embodiment, this invention relates to a method as recited above, wherein said open cells have a cell size of 0.8±0.3 μm.

In yet another embodiment, this invention relates to a method as recited above, wherein said foam has an R value of between 2 and 15 per inch of thickness.

In one embodiment, this invention relates to a method as recited above, wherein said open cell silicone foam is used to insulate the exterior surface of a wall of said building, and a closed cell silicone foam is used to insulate the interior surface of said wall.

In another embodiment, this invention relates to a method for insulating as recited above, wherein said open cell polyurethane foam is applied to a sheathing material to provide a silicone foam layer on the sheathing material.

In yet another embodiment, this invention relates to a method for insulating as recited above, further comprising covering said open cell polyurethane foam layer with brick, wood, wood siding, wood composite siding, vinyl siding, or aluminum siding.

In one embodiment, this invention relates to a method for insulating the exterior surface of a building comprising:
spraying a mixture of silicone pre-polymers on to a sheathing material of the building to produce a silicone foam layer on the sheathing material, wherein said foam is prepared by reacting a first silicone pre-polymer, as an A component, and a second silicone pre-polymer as a B Component, wherein one or both components comprise the non-fluorinated blowing agents, and optionally at least one surfactant, and said silicone foam layer having an open-cell, close-cell, or hybrid structure, wherein said polyurethane foam has a foam density of between 50 and 350 kg/m³, and has a cell size of between 0.03 μm and 1.5 μm, so that said silicone foam layer acts as a water and air barrier, while also being water permeable; and
covering said open cell silicone foam layer with brick, wood, wood siding, wood composite siding, vinyl siding, or aluminum siding.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates an embodiment of the present invention directed to Silicone Foams Prepared with ELKEM™ Polymers.

FIG. 2A illustrates an embodiment of the present invention directed to ELKEM™ 3240 Density as a Function of Blowing Agent Concentration.

FIG. 2B illustrates an embodiment of the present invention displaying ELKEM™ 3242 Density as a Function of Blowing Agent Concentration.

FIG. 3 illustrates an embodiment of the present invention displaying change in Cell-Structure of ELKEM™ 3230 with Blowing Agent Concentration Increase: 0%, 5%, and 10%.

FIG. 4 illustrates an embodiment of the present invention showing change in Cell-Structure of ELKEM™ 3242 with Blowing Agent Concentration Increase: 0%, 5%, and 10%.

FIG. 5 shows a benchmark example of Low-Density Foam from International Silicone Foams (ISC).

FIG. 6 shows a benchmark example of Low-Density Foam from Rogers' Corporation.

FIG. 7A shows Density of Three Foams with No Blowing Agent and 10% Blowing Agent (methylal).

FIG. 7B shows Foam Cell Structure with Zero Blowing Agent Concentration and 10% Concentration (methylal).

FIG. 8A shows Density of Two Foams with No Blowing Agent and 10% Blowing Agent (Methyl Formate).

FIG. 8B shows Foam Cell Structure with Zero Blowing Agent Concentration and 10% Concentration (Methyl Formate).

FIG. 9A illustrates an embodiment of the present invention showing Density of Two Foams with 5% Blowing Agent and 10% Blowing Agent (Pentane).

FIG. 9B illustrates an embodiment of the present invention showing Foam Cell Structure with 5% Blowing Agent Concentration and 10% Concentration (Pentane).

FIG. 10A illustrates an embodiment of the present invention showing Density of Three Foams (ELKEM™ 3230) with 0%, 5%, and 10% Blowing Agent (Cyclopentane).

FIG. 10B illustrates an embodiment of the present invention showing Foam Cell Structure from Silicone Foam 3230 with 5% Blowing Agent Concentration and 10% Concentration (Cyclopentane).

FIG. 11 illustrates an embodiment of the present invention showing Foam Cell Structure from Silicone Foam 3230 with 10% Blowing Agent Concentration and 1% Concentration (Opteon™ 1100—a Fluorinated Blowing Agent).

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting. As used in the specification and in the claims, the term “comprising” may include the embodiments “consisting of” and “consisting essentially of.”

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. Thus, if a class of adhesives A, B, and C are disclosed as well as a class of additives D, E, and F and an example of a combination A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B—F, and C-E are specifically contemplated and should be considered disclosed from disclosure of A, B, and C; D, E, and F; and the example combination A-D. This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Unless expressly stated otherwise, it is not intended that any method outlined herein be construed as requiring that its steps be performed in a particular order. Accordingly, where a method claim does not expressly recite an order to be followed by its steps, or where neither the claims nor the descriptions specifically state that the steps are to be limited to a precise sequence, it should not be inferred that a specific order is intended or required. This holds for any possible non-express basis for interpretation, including, but not limited to: logical flow or arrangement of steps; interpretations derived from the grammatical organization, syntax, or punctuation; and the quantity or variety of embodiments detailed in the specification. The description of the invention should not be read as mandating a fixed sequence of steps, unless such a requirement is articulated explicitly.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise. As used in the specification and the appended claims, the singular forms “a,” “an,” and “the” include plural referents unless the context clearly dictates otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

All parts, percentages and ratios used herein are expressed by weight unless otherwise specified.

In this specification and in the claims which follow, reference will be made to a number of terms which shall be defined herein.

“Optional” or “optionally” means that the subsequently described event or circumstance can or cannot occur, and that the description includes instances where the event or circumstance occurs and instances where it does not.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. Throughout this application, various publications are referenced. The disclosures of these publications in their entireties are hereby incorporated by reference into this application in order to more fully describe the state of the art to which they pertain. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation. In the context of the present description, all publications, patent applications, patents and other references mentioned herein, if not otherwise indicated, are explicitly incorporated by reference herein in their entirety for all purposes as if fully set forth.

The following describes exemplary embodiments of the present invention in the building construction context, which pertains to insulation, water permeation, and fire-retardation, among other things.

### Definitions

Silicone polymers and pre-polymers as well as the blowing agents are defined in their respective sections, infra.

By “open-celled” structure is meant that the resulting foam is substantially open-celled in its structure.

By “closed-cell” structure or close-cell structure is meant that the resulting foam is substantially close-celled.

By “substantially” in the above context is meant that at least 20% of the cells in the resulting foam are one way or the other way.

By a “hybrid-cell” structure is mean that the resulting foam has both open- and close-celled structure substantially speaking.

By a “silicone pre-polymer” is meant a material that is capable of polymerizing into a higher molecular weight polymer that is higher than the silicone-prepolymer. The pre-polymer can me monomeric, dimeric, trimeric, or oligomeric.

By “pre-foam mix” or “foam pre-mix” is meant the material that comprises at a minimum the silicone pre-polymer, and optionally, at least one blowing agent. The premix can also have other optional ingredients in it, for example, a second blowing agent, an emulsifier, a surfactant, a surface tension depressant, a wetting agent, a chemically active blowing agent, a catalyst, a filler material, a viscosity modifier, and a physically active agent such as a microbial mitigation agent.

By “foamable” is meant that the silicone pre-polymer is capable of forming into a foam.

By “non-fluorinated” blowing agent is meant that the blowing agent used for preparing the foam material does not comprise one or more fluorine atoms in its chemical structure.

By “partially-cured” silicone polymer is meant that the foamed silicone polymer is not substantially cured. By “substantially cured” is meant that the silicone polymeric foam is more than 80% cured at that given temperature, from a chemical standpoint.

This invention relates to a pre-foam mix comprising:
(i) at least one foamable silicone pre-polymer; and
(ii) one blowing agent comprising at least one non-fluorinated blowing agent.

The silicone polymers and the blowing agents are described below.

### Silicones

In the silicone prepolymer, the silicone pre-polymer concentration can range from 100% to 60%. Stated differently, the silicone pre-polymer concentration the silicone premix optionally comprising unfluorinated blowing agents is one of the numbers in terms of weight percent of the premix: 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

In one embodiment, the silicone pre-polymer concentration by weight is within a range defined by any two numbers above, including the endpoints of such a range.

Silicones used for preparing the foam for the present invention include Silicone polymers represent inorganic/organic hybrid polymers with Si—O—Si— typical inorganic backbone and organic Methyl or Phenyl groups attached to the silicon atoms (Me-Si or Ph-Si). Silicone polymers do not require toxic isocyanate starting materials. Due to inorganic/organic nature of the silicone polymers, they form special “self-extinguishing” class of the polymers. They don't require additions of flame-retardants in many applications. Silicone foams are synthesized by using hydrogen gas as a blowing agent. Source of the hydrogen is incorporated in the one of the silicone polymers with Si—H fragment. Si—H moiety typically reacts with Si—OH fragment of other silicone polymer in the foam formulation with the liberation of hydrogen gas, which acts as blowing agent. This foaming process has the limited amounts of hydrogen available for the foaming process if the silicone foam with less density desired or more silicone open foam is desired. Addition of the second or third or azeotropic blowing agents was envisioned to prepare cost-efficient silicone foams with less density and more open cell structures. Addition of low-boiling non-fluorinated acetals, for example, methylal was explored and claimed for the silicone foam production in this application.

Silicones for the present invention include Dow Chemical's Dowsil 3-6548 and ELKEM™ silicones 3230A, 3230B, 3242A, and 3242B. Also included are the Bluestar Silicones from Elkem.

Other silicones pre-polymers and foams used for preparing foam include the ones described in the following references, which are incorporated in relevant parts by reference herein, include: U.S. Pat. Nos. 9,056,953; 10,829,609; 5,153,231; 4,719,243; 10,744,225; 3,428,580; ES2787849T3; U.S. Pat. No. 10,857,758; US20160053069; US20100192289; and CA3045033.

For comparison purposes the following silicone foams were used:

### International Silicone Foams (ISC)

### Class of Low-Density Foam

Cell structure: Open.
Sealing: Excellent.
Density: 150 (kg/m3) or 9.36 (pcf)
Thermal Conductivity: 0.09 W/m∘k

### Rogers Corporation

Class of Low-Density Foam (kSil 200)
Cell structure: Hybrid (Open/Closed).
Sealing: Excellent.
Density: 150 (kg/m3) or 9.36 (pcf)
Thermal Conductivity: 0.064 W/m∘k

In one embodiment, this invention relates to preparing a mixture of the blowing agents to obtain a desired density and/or desired cell-structure in the silicone foams, for example, open, closed, or hybrid. In one embodiment, one or more or all of the blowing agents are all non-fluorinated. In another embodiment, one or more of the blowing agents may be fluorinated.

### Blowing Agents

In one embodiment, the blowing agent comprises one or more of the following non-fluorinated compounds: methylal, ethylal, propylal, butylal, tetraoxaundecane, 1,3-dioxolane, 2-ethylhexylal, glycerol formal, dimethyl acetal, fructone, mixtures thereof, and combinations thereof.

In another embodiment, the above listed blowing agents are combined with water. In another embodiment, the present invention uses methylal to prepare silicone based rigid foams, spray foams, flexible molded foams, and one-component foams to be used in the building construction industry.

In another embodiment, the following blowing agents are used in combination with the above-listed non-fluorinated blowing agents to prepare silicone-based foams, preferably for the construction industry: methyl formate, cyclopentane, n-pentane, isopentane, HFO-1233-zd-E, HFC-245fa, HFC-365mfc, HFO-1336 mzz-Z, HFC-227ea. HFO-1336 mzz-Z is also known as Opteon™ 1100 or Formace™ 1100 and can be purchased from the Chemours Co. of Delaware.

In one embodiment, methylal is blended with polyols to reduce flammability. Once methylal is blended with polyols, the blend's vapor pressure decreases and the flash point increases. Blends of polyols of higher viscosity with methylal have a higher flash point.

In one embodiment, silicone such as silicone polyether copolymer emulsifier is added to polyol-methylal blends to increase the flash point. An exemplary polyol is polyether triol. The silicone polyether can act as a surface tension depressant, wetting agent, and a foam builder.

In one embodiment, the blowing agent concentration, by weight of the silicone pre-polymer mix with the blowing agent is in the range of 0% to about 20%. Stated differently, the concentration of the blowing agent as recited above, is any one number selected from the set of following numbers in weight % concentration of the total weight of the pre-polymer mix that comprises at least one silicone pre-polymer, the blowing agent, and other ingredients: 0, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20.

In one embodiment, the concentration of the blowing agent as recited above is any number within a range defined by any two numbers above including the endpoints of such range.

In one embodiment, methylal is combined with one or more other blowing agents as described above to engender better miscibility of the other blowing agent, better flow, better foam uniformity, control of the cell size, and better adhesion to metallic surfaces.

In one embodiment, a cell regulator surfactant is added to the blowing agent or to the silicone pre-polymer mix with the blowing agent.

In one embodiment, methylal is used in combination with hydrogen has as the blowing agent.

Further blowing agents that can be used in the present invention include low-boiling acetals or ketals, for example, ethylal (EtO)₂CH₂; DMA (MeO)₂CH(Me) or cyclic derivatives, for example, dioxolane: [—CH₂—CH₂—O—CH₂—]. In one embodiment, these low boiling acetals or ketals are used in combination with different proportions of methylal to moderate exotherm of the silicone foam process. The control of the silicone foam exotherm, and thereby controlling the density and the closed-cell or open-cell aspect of the silicone-based foam is an aspect of the present invention.

In one embodiment, the following blowing agents are used with various combination and proportions: methylal, cyclopentane, pentane, methyl formate, and Opteon™ 1100.

In one embodiment of the invention, the following thermal blowing agents individually or as a blend are used in the silicone foams: methylal, cyclopentane, pentane, methyl formate, and Opteon™ 1100.

In another embodiment, chemically active blowing agents such as diols and triols can also be used to prepare the silicone foams, for example, 1,4-butanediol, 1,2,3-propanetriol.

In one embodiment, chemically activated blowing agents are also considered in the process described above.

Accordingly, in one aspect, the present invention provides a silicone foam for use in insulating an exterior surface of a building, wherein said silicone foam has an open-cell structure, and preferably has a foamed density of between 50-350 Kg/m³.

Preferably, the open cell structure of the foams of the present invention have a structure wherein the cells are essentially open but include some randomly occurring, solid cell walls.

In one embodiment, the open cell structure of the foams of the present invention is formed by a combination of surfactants that results in a surfactant interaction which produces both completely open and at least partially open, cell walls. In one embodiment, if measured by a method such as AS™ D6226, the open cell content of the foams of the present invention is preferably greater than 80%, and more preferably, greater than 80%.

The size of the cell can vary depending on the materials used, and the amount of blowing agent, and the like, which is used. Preferably, the foams of the present invention have a cell size of between 0.03 μm, and 1.5 μm, and more preferably between 0.1 μm and 1.0 μm.

The insulating ability (for example the “R” value) of the foam is preferably such that the silicone foam of the present invention will provide an R value of between 2 and 20 per inch of thickness. As such, typical “R” values would be between the ranges of 4 and 12 for a 2 inch thickness foam.

In an exemplary implementation of the present invention, a first silicone pre-polymer (Component A) is mixed with a second silicone pre-polymer (Component B), at room temperature or under heat, so that the two components react and foam. Preferably, the two components are mixed in the spray nozzle of a spray gun.

In another aspect, the present invention provides a semi-rigid, silicone foam, for use in insulating an exterior surface of a building, wherein said sprayed silicone foam has an open cell structure and density, as previously described with respect to the present invention.

In another aspect, the present invention provides a method for insulating the exterior surface of a building comprising spraying the exterior surface of the building with the foamed reaction mixture of one or more silicone pre-polymers in order to produce a silicone foam having an open cell structure and density, as previously described with respect to the present invention.

The general production methods to produce silicone foams are well known to the skilled artisan, as is the general chemistry for production thereof. As such, these will not be described in any specific detail

The nature, types and amounts of blowing agents which are used in silicone foam manufacture are well known to those skilled in the art, but can include, for example, water, carbon dioxide, hydrofluorocarbons (HFCs), chlorinated fluorocarbons, hydrofluro olefins (HF0s), and the like.

In contrast, for the present invention, non-fluorinated blowing agent is the preferred blowing agent for formulations of the present invention. In the formulations used for preparing the silicone foams of the present invention, the non-fluorinated blowing agent will be present at a concentration of from 0.5 to 40 weight percentage of B-side component.

Alternatively, other blowing agents can be used, or combined with the non-fluorinated blowing agents such as methylal, in order to generate a gaseous material during the curing reaction. While carbon dioxide is a preferred gas for generation, other gases such as hydrogen, nitrogen, pentane, and fluorinated blowing agents such as HF0s, HFCs, or the like, may be released, or directly used, in order to form a foam with the desired density and cell shape and size.

The total amount and type of blowing agent is selected however, so as to provide a silicone foam having the desired density range.

The silicone foam material of use in the present invention can also be custom formulated and engineered for specific applications. The range of formulations includes using rigid, semi-rigid, or more preferably semi-flexible or flexible, silicone foams that may include a range of organic and inorganic reinforcing materials which may be in the form of a particle or fiber with the said reinforcing materials being in a variety of densities, sizes and regular and irregular shapes.

Additionally, other additives such as catalysts or surfactants, or the like, can be added to the reaction mixture in order to control various properties of the silicone foam.

Surfactants are also preferably included to provide the proper cell structure, and these are silicone based. However, any suitable surfactants might be used. By introducing surfactants, the foam materials can be caused to make more cells, and by proper selection of surfactants, the preferred combination of open and partially-closed cell configurations of the present invention can be achieved.

Preferred surfactants include combinations of cell opening-promoting surfactants like Evonik TEGOSTAB B8523, B8580, B84710, B8870, Ortegol 204, Ortegol 500, and Ortegol 501, and closed cell-promoting surfactants like Evonik TEGOSTAB B8408, B8453, and B8487.

Preferably, the systems of the present invention include combinations of these types of surfactants to produce open cells have some randomly occurring, solid cell walls.

The total amount of surfactants present is preferably between 0.1 and 10% by weight of the B-side component, and more preferably, between 1 and 6%, by weight. Most preferably, the weight of the surfactant is between 2 and 4% by weight of the B-side component.

The mixture of open cell and closed cell promoting surfactants, in the total surfactant added, is preferably such that the open cell promoting surfactant accounts for between 10 to 90% by weight of the surfactant mixture.

The amount and ratio of the surfactant types is selected to provide the desired cell size, foam density, and amount of essentially open cells with some cells including some randomly occurring, solid cell walls.

Where uniformity of cell structure is required, fine organic or inorganic particles in a size range between 50 and 500 microns, may be added.

Other materials can be included in the formulations of the present invention. For example, coupling agents, such as silane or titanates, may also be included in the preparation of the composition to improve the physical properties of the material. Where other properties are desired, additional additives may be added to the composition including colorants, dry or liquid inks or pigments, fire and flame retardants, UV absorbers and protectants, antistatic agents, and such other additives as required, and which are known within the industry.

Silicone foam generally denotes a polyorganosiloxane composition in the foam form. Silicone foams preparation is described in a many patents. However, the present invention uses non-fluorinated blowing agents to make the silicone foams.

With regard to silicone foams, several techniques exist for producing them. A first technique employs a condensation reaction with release of volatile by-products. This is the case in particular for systems using the condensation reaction of the SiH—SiOH type, which makes it possible to release hydrogen which then acts as a porogenic agent. For example, French patent No. FR-A-2 589 872 describes a silicone foam precursor composition comprising an organosilicon polymer comprising siloxane units having hydroxyl groups bonded to the silicon, an organosilicon polymer comprising siloxane units having hydrogen atoms bonded to the silicon, a catalyst, for example a tin compound, and a finely divided filler comprising silica which has been treated to become hydrophobic.

A variant described in U.S. Pat. No. 3,923,705 consisted in providing compositions comprising polydiorganosiloxanes bearing hydrogen atoms bonded to the silicon available for a condensation reaction with polydiorganosiloxanes bearing hydroxyl groups bonded to the silicon (silanols) in the presence of a platinum catalyst. This reaction thus makes it possible to construct the network while producing hydrogen gas necessary for the formation of a silicone foam. In this type of formulation, the formation of gas is proportional to the rate of crosslinking and consequently the density of the foams obtained is difficult to control, thus explaining the difficulties in obtaining low-density foams by this technique.

According to another variant described in U.S. Pat. No. 4,189,545, silicone foams are prepared from a composition comprising water, a polydiorganosiloxane bearing vinyl groups bonded to the silicon, a polydiorganosiloxane containing hydrogen atoms bonded to the silicon and borne by units in the chain and not exclusively at the chain end, in order to be able to act as a crosslinking agent. The water reacts with the polysiloxane comprising hydride functions, thus producing hydrogen gas and a silanol. The silanol then reacts with the polydiorganosiloxane comprising hydride functions via a condensation reaction, thus generating a second molecule of hydrogen gas, while another polydiorganosiloxane bearing vinyl groups bonded to the silicon will simultaneously react, via an addition reaction, with another polydiorganosiloxane comprising a hydride function, thus participating in the construction of the network of the silicone foam.

In U.S. Pat. No. 4,590,222, silicone foams are prepared from a composition comprising a polydiorganosiloxane, a resin, a platinum-based catalyst, an organohydro-siloxane, a polyorganosiloxane bearing hydroxyl groups on the chain-end units, a filler and an organic alcohol.

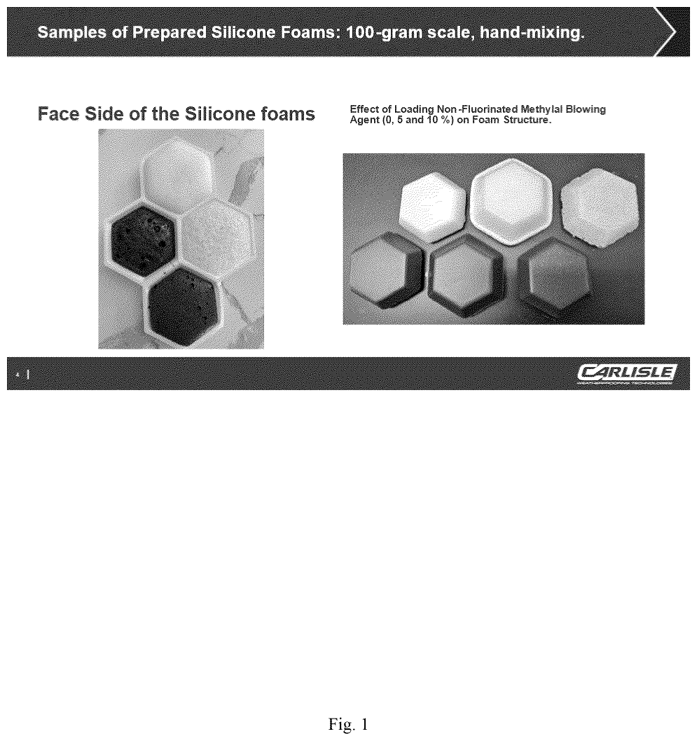

Referring to the Figures, FIG. 1 illustrates an embodiment of the present invention directed to Silicone Foams Prepared with ELKEM™ Polymers. This embodiment demonstrates the formation of silicone foams using partially-cured silicone polymers that are mixed with non-fluorinated blowing agents, such as methylal or pentane. The process involves combining the silicone prepolymer components under controlled mixing conditions to ensure optimal incorporation of the blowing agent. The resulting foam exhibits a uniform cellular structure and enhanced physical properties, suitable for applications requiring low-density, resilient materials. Variation in the blowing agent concentration directly influences the final foam density and cell morphology.

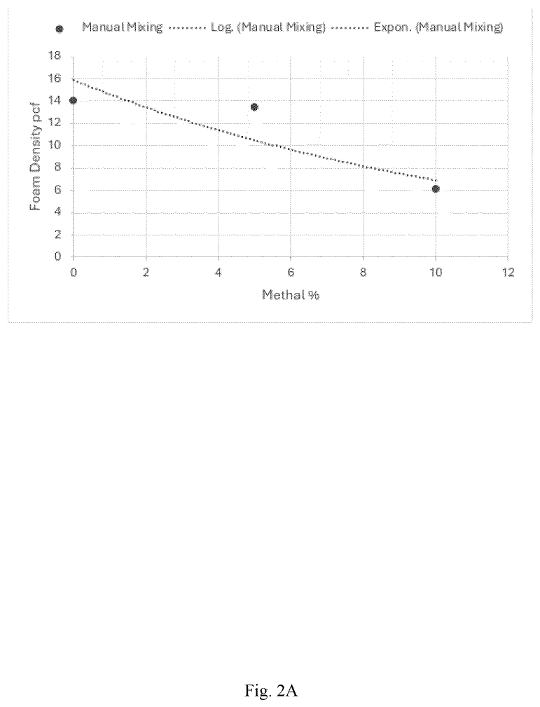

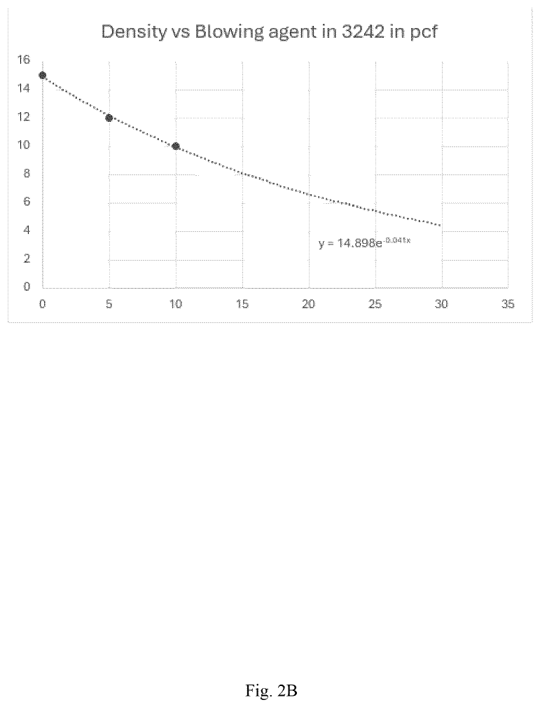

FIG. 2A illustrates several embodiments of the present invention comparing the density of silicone foams made with ELKEM™ 3240 as a Function of Blowing Agent Concentration. This figure presents detailed data correlating the density of foams produced from ELKEM™ 3240 polymers with increasing amounts of a non-fluorinated blowing agent. As the loading of methal blowing agent is increased from 0% to 10% by weight, there is a marked decrease in the resulting foam density, confirming the effectiveness of the expansion mechanism.

FIG. 2B illustrates an embodiment of the present invention displaying ELKEM™ 3242 Density as a Function of Blowing Agent Concentration. The data in this embodiment reveal a trend in density reduction analogous to that observed with ELKEM™ 3240. The addition of non-fluorinated blowing agents to the partially-cured silicone polymer system results in a steady decline in foam density.

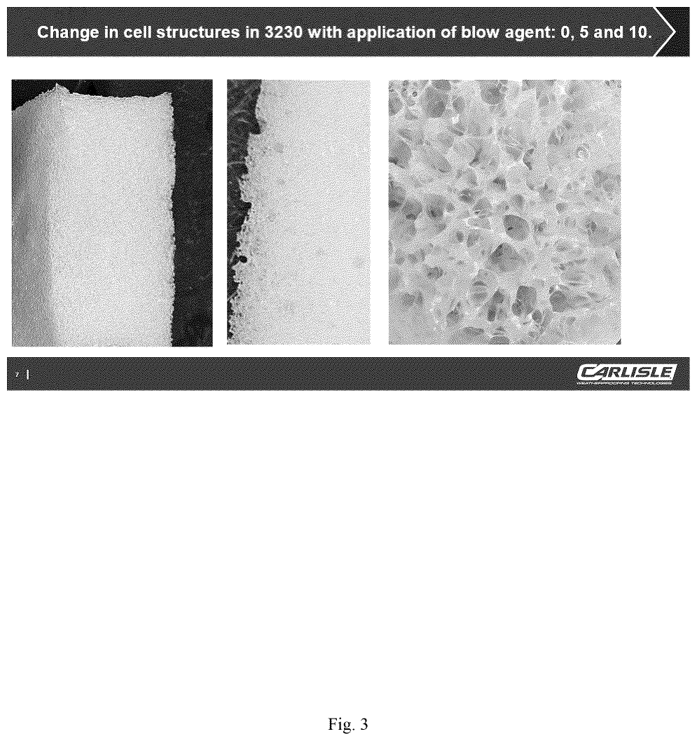

FIG. 3 illustrates an embodiment of the present invention displaying change in Cell-Structure of ELKEM™ 3230 with Blowing Agent Concentration Increase: 0%, 5%, and 10%. This figure illustrates the morphological evolution of foam cells as the concentration of non-fluorinated blowing agent is incrementally increased. At 0% blowing agent, the foam structure is predominantly closed-cell, while higher concentrations promote open-cell formation and reduced density. The partially-cured silicone matrix enables the formation of interconnected pore networks without collapse or coalescence. Such tunable cell structure enhances breathability and mechanical flexibility in the final foam product.

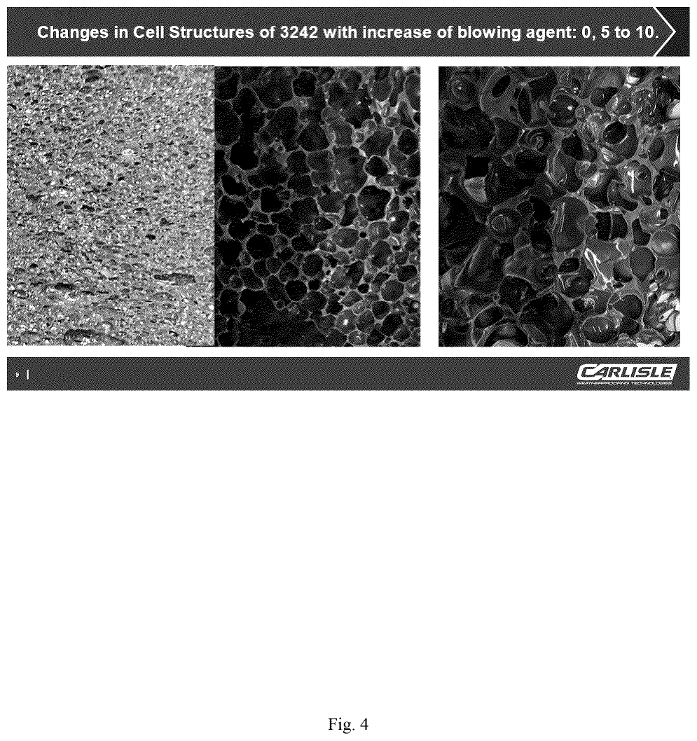

FIG. 4 illustrates an embodiment of the present invention showing change in Cell-Structure of ELKEM™ 3242 with Blowing Agent Concentration Increase: 0%, 5%, and 10% from left to right. In this figure, the relationship between blowing agent concentration and cell architecture is explored further with the ELKEM™ 3242 system. The photos illustrate that as the loading of the non-fluorinated blowing agent is increased, the foam transitions from a denser, closed-cell morphology to a lighter, open-cell configuration. This transformation allows for customization of insulating or cushioning properties depending on the application. The method preserves the uniformity and integrity of the foam, even at higher expansion levels.

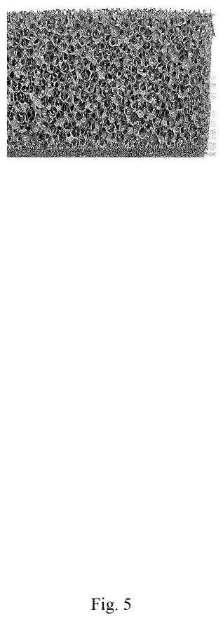

FIG. 5 shows a benchmark example of Low-Density Foam from International Silicone Foams (ISC). For comparative analysis, this figure illustrates a commercial low-density silicone foam from ISC as a benchmark. The inventive foams comprising partially-cured silicone polymers and non-fluorinated blowing agents achieve comparable or superior density reduction and physical characteristics. Side-by-side evaluation highlights advantages in process simplicity and environmental safety due to the non-fluorinated nature of the blowing agents used in the present invention.

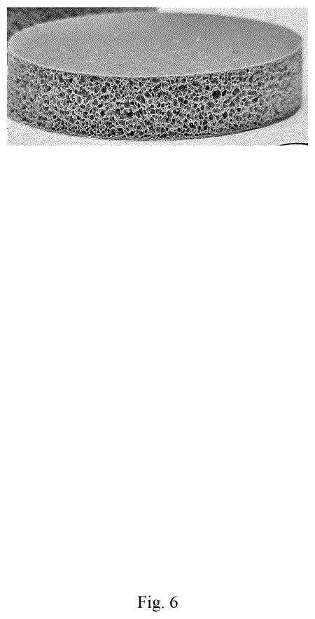

FIG. 6 shows a benchmark example of Low-Density Foam from Rogers Corporation. Similarly, foams developed according to the invention can be compared to the low-density silicone foams from the Rogers Corporation. The foams of the present invention can match or exceed the performance benchmarks in terms of density, cell uniformity, and mechanical stability.

### EXPERIMENTAL

Methylal showed good solubility in both parts “A” and “B” of the silicone pre-polymers. Thus, calculated amount of blowing agent was pre-dissolved in part “A” and/or Part “B”, and above parts are mixed in 50-gram quantities each with vigorous mixing. After initial bubbling formation, the resultant mixture was casted into the molding forms. Curing of the foam at room temperature takes about half an hour or even shorter. Complete curing of surface tackiness may take 1 or 2 days at room temperature. After that silicon foams can be cut in smaller pieces for the analysis.

Samples of the foams prepared from ELKEM™ pre-polymers are presented in the figures.

For the present experiments, silicones were purchased commercially from the several manufacturers, for example, ELKEM™ and Dow Chemicals.

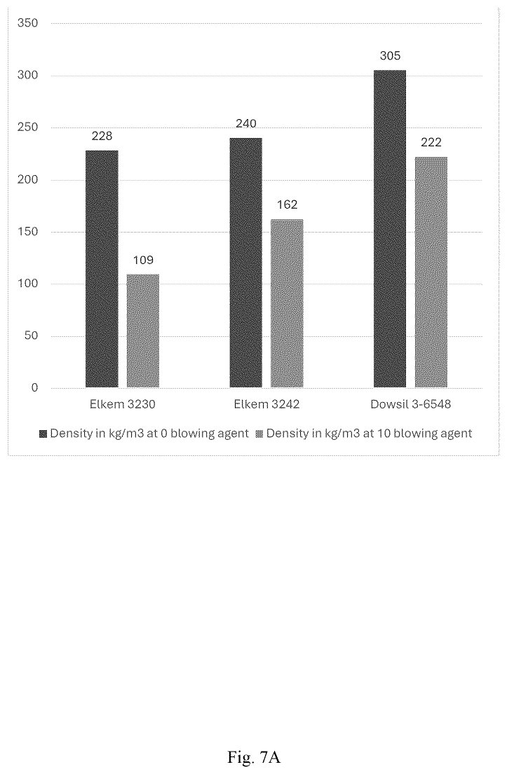

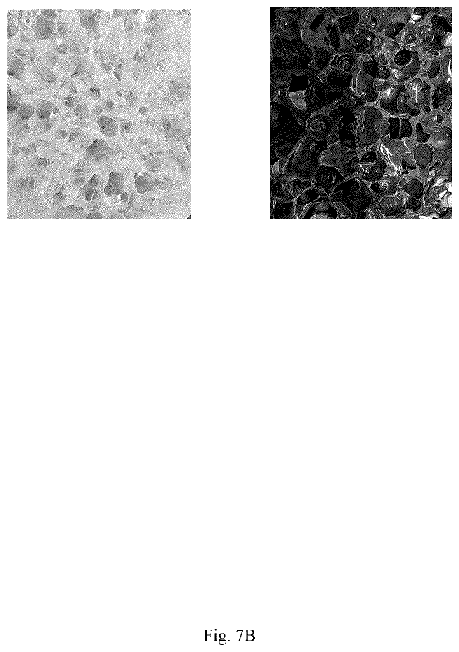

FIG. 7 shows the density decrease of the silicone foam prepared from ELKEM™ 3230, ELKEM™ 3242, and Dowsil 3-6548 silicone prepolymers when methylal is used as blowing agent. A decrease of about 53% was found with a 10% concentration of methylal over 0% methylal concentration.

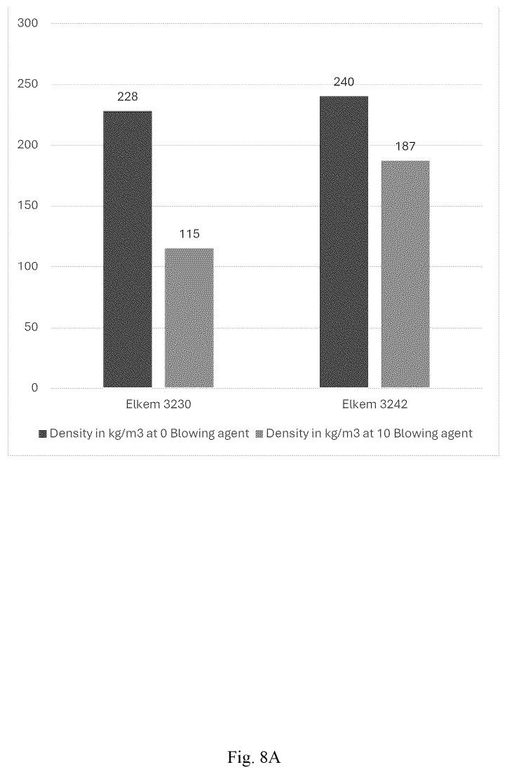

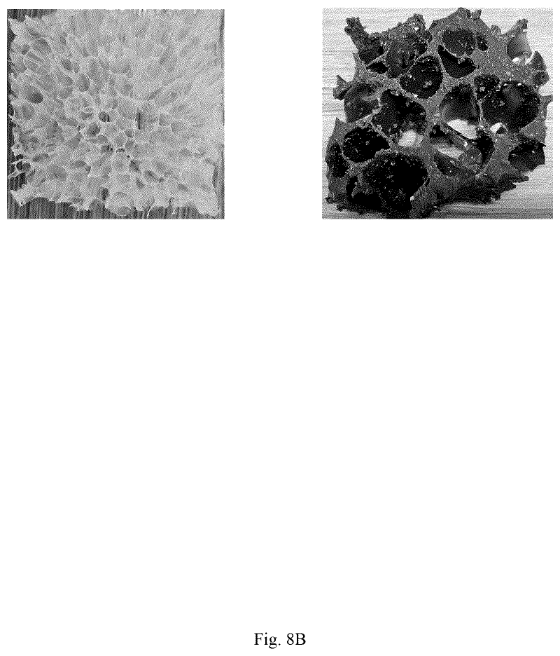

FIG. 8 shows methyl formate as the blowing agent and ELKEM™ 3230 and 3242 as the silicone. The density was reduced from 172 Kg/m3 prepolymers. There was a 50% reduction in density for both silicone foams when 0% blowing agent was used versus when 10% was used.

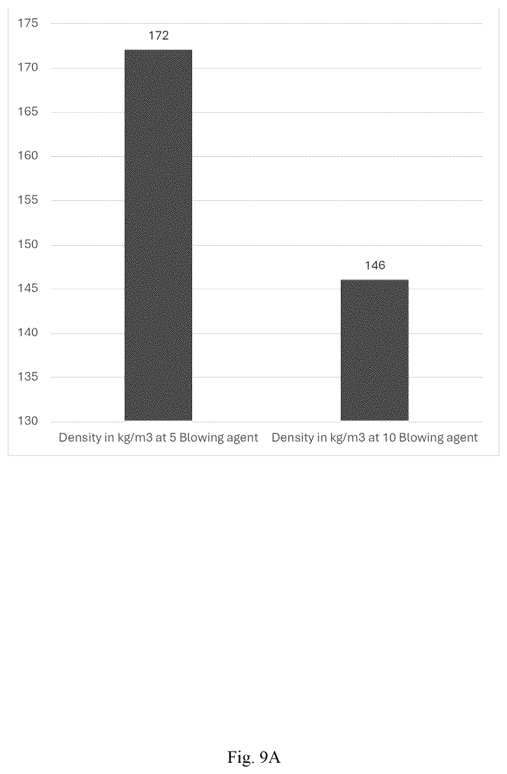

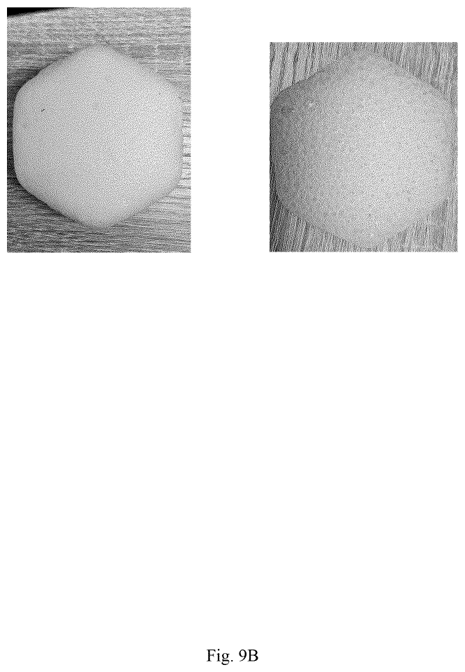

FIG. 9 shows pentane as the blowing agent and ELKEM™ 3230 as the silicone prepolymer. The density was reduced from 172 kg/m³ to 146 kg/m³ when 5% blowing agent was used versus 10%. Also, the cell structure changed from close-cell to open-cell.

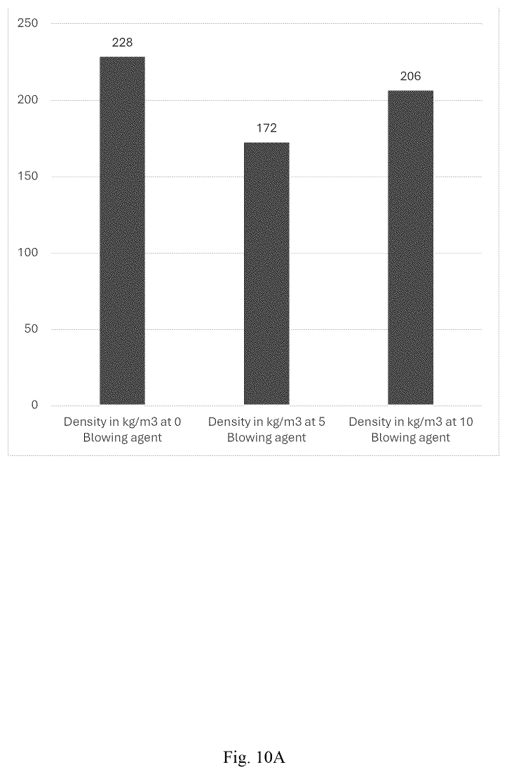

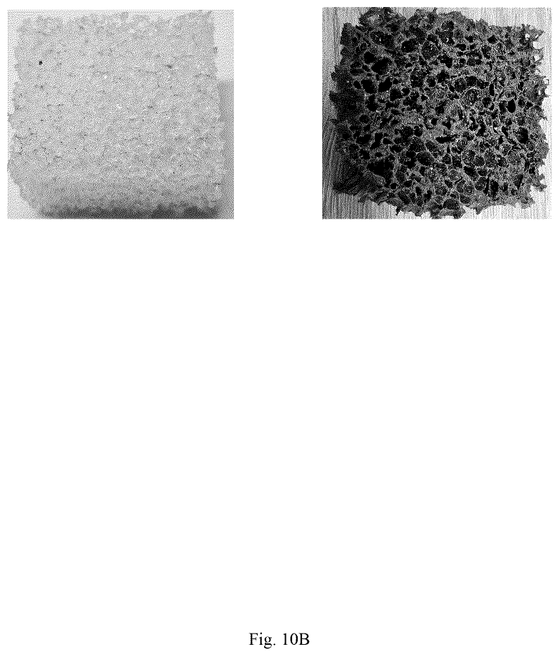

FIG. 10 shows cyclopentane as blowing agent and ELKEM™ 3230 as the silicone prepolymer with the cyclopentane loadings of 0%, 5%, and 10%. Density increased back at a higher 10% loading of the cyclopentane.

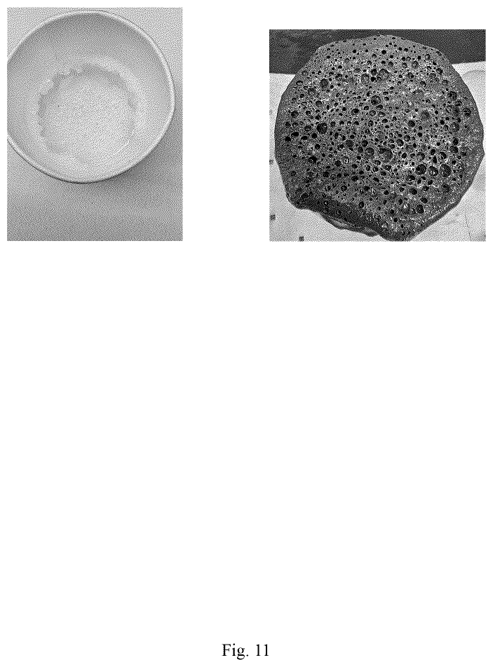

As shown in FIG. 11, when Opteon™ 1100 was used as the blowing agent with the ELKEM™ 3230 silicone prepolymer, and Dow prepolymers, the samples did not cure after a long time. For example, the foams with 10% and even 1% of loading of Opteon™ 1100 are still not cured after 3 weeks. Without wishing to be bound by theory, we surmise that this fluorinated blowing agent retards the formation of the silicone foams by deactivation of the catalysts, Si—H abstraction or hydrosilylation reaction on carbon-carbon double bond.

In conclusion, the present invention relates to a non-requirement of isocyanate in preparing foams, because they are silicone foams. Also, the application of the blowing agents based on the thermal expansion mechanism resulted in the decrease of density of the foams up to 50%. In one embodiment, the numerical density of the resultant foams was found to be close to commercial low-density silicone foams between 100 to 150 kg/m³. In one embodiment, the order of blowing agents was found as the following:

Methylal>Methyl Formate>Pentane>Cyclopentane>>Opteon™ 1100 Opteon™ 1100 is a commercial foam blowing agent known in the art that is based on hydrofluoroolefin (HFO) chemistry and sold by Chemours.

In one embodiment, chemically activated blowing agents are also considered in the process described above.

Accordingly, in one aspect, the present invention provides a silicone foam for use in insulating an exterior surface of a building, wherein said silicone foam has an open-cell structure, and preferably has a foamed density of between 50-350 Kg/m³.

Preferably, the open cell structure of the foams of the present invention have a structure wherein the cells are essentially open but include some randomly occurring, solid cell walls.

In one embodiment, the open cell structure of the foams of the present invention is formed by a combination of surfactants that results in a surfactant interaction which produces both completely open and at least partially open, cell walls. In one embodiment, if measured by a method such as AS™ D6226, the open cell content of the foams of the present invention is preferably greater than 80%, and more preferably, greater than 80%.

The size of the cell can vary depending on the materials used, and the amount of blowing agent, and the like, which is used. Preferably, the foams of the present invention have a cell size of between 0.03 μm, and 1.5 μm, and more preferably between 0.1 μm and 1.0 μm.

The insulating ability (for example the “R” value) of the foam is preferably such that the silicone foam of the present invention will provide an R value of between 2 and 20 per inch of thickness. As such, typical “R” values would be between the ranges of 4 and 12 for a 2 inch thickness foam.

In an exemplary implementation of the present invention, a first silicone pre-polymer (Component A) is mixed with a second silicone pre-polymer (Component B), at room temperature or under heat, so that the two components react and foam. Preferably, the two components are mixed in the spray nozzle of a spray gun.

In another aspect, the present invention provides a semi-rigid, silicone foam, for use in insulating an exterior surface of a building, wherein said sprayed silicone foam has an open cell structure and density, as previously described with respect to the present invention.

In another aspect, the present invention provides a method for insulating the exterior surface of a building comprising spraying the exterior surface of the building with the foamed reaction mixture of one or more silicone pre-polymers in order to produce a silicone foam having an open cell structure and density, as previously described with respect to the present invention.

The general production methods to produce silicone foams are well known to the skilled artisan, as is the general chemistry for production thereof. As such, these will not be described in any specific detail

The nature, types and amounts of blowing agents which are used in silicone foam manufacture are well known to those skilled in the art, but can include, for example, water, carbon dioxide, hydrofluorocarbons (HFCs), chlorinated fluorocarbons, hydrofluro olefins (HF0s), and the like.

In contrast, for the present invention, non-fluorinated blowing agent is the preferred blowing agent for formulations of the present invention. In the formulations used for preparing the silicone foams of the present invention, the non-fluorinated blowing agent will be present at a concentration of from 0.5 to 40 weight percentage of B-side component.

Alternatively, other blowing agents can be used or combined with the non-fluorinated blowing agents such as methylal, in order to generate a gaseous material during the curing reaction. While carbon dioxide is a preferred gas for generation, other gases such as hydrogen, nitrogen, pentane, and fluorinated blowing agents such as HF0s, HFCs, or the like, may be released, or directly used, to form a foam with the desired density and cell shape and size.

The total amount and type of blowing agent is selected however, so as to provide a silicone foam having the desired density range.

The silicone foam material of use in the present invention can also be custom formulated and engineered for specific applications. The range of formulations includes using rigid, semi-rigid, or more preferably semi-flexible or flexible, silicone foams that may include a range of organic and inorganic reinforcing materials which may be in the form of a particle or fiber with the said reinforcing materials being in a variety of densities, sizes and regular and irregular shapes.

Additionally, other additives such as catalysts or surfactants, or the like, can be added to the reaction mixture in order to control various properties of the silicone foam.

Surfactants are also preferably included to provide the proper cell structure, and these are silicone based. However, any suitable surfactants might be used. By introducing surfactants, the foam materials can be caused to make more cells, and by proper selection of surfactants, the preferred combination of open and partially-closed cell configurations of the present invention can be achieved.

Preferred surfactants include combinations of cell opening-promoting surfactants like Evonik TEGOSTAB B8523, B8580, B84710, B8870, Ortegol 204, Ortegol 500, and Ortegol 501, and closed cell-promoting surfactants like Evonik TEGOSTAB B8408, B8453, and B8487.

Preferably, the systems of the present invention include combinations of these types of surfactants to produce open cells have some randomly occurring, solid cell walls.

The total amount of surfactants present is preferably between 0.1 and 10% by weight of the B-side component, and more preferably, between 1 and 6%, by weight. Most preferably, the weight of the surfactant is between 2 and 4% by weight of the B-side component.

The mixture of open cell and closed cell promoting surfactants, in the total surfactant added, is preferably such that the open cell promoting surfactant accounts for between 10 to 90% by weight of the surfactant mixture.

The amount and ratio of the surfactant types is selected to provide the desired cell size, foam density, and amount of essentially open cells with some cells including some randomly occurring, solid cell walls.

Where uniformity of cell structure is required, fine organic or inorganic particles in a size range between 50 and 500 microns, may be added.

Other materials can be included in the formulations of the present invention. For example, coupling agents, such as silane or titanates, may also be included in the preparation of the composition to improve the physical properties of the material. Where other properties are desired, additional additives may be added to the composition including colorants, dry or liquid inks or pigments, fire and flame retardants, UV absorbers and protectants, antistatic agents, and such other additives as required, and which are known within the industry.

Silicone foam generally denotes a polyorganosiloxane composition in the foam form. Silicone foams preparation is described in a many patents. However, the present invention uses non-fluorinated blowing agents to make the silicone foams.

With regard to silicone foams, several techniques exist for producing them. A first technique employs a condensation reaction with release of volatile by-products. This is the case in particular for systems using the condensation reaction of the SiH—SiOH type, which makes it possible to release hydrogen which then acts as a porogenic agent. For example, French patent No. FR-A-2 589 872 describes a silicone foam precursor composition comprising an organosilicon polymer comprising siloxane units having hydroxyl groups bonded to the silicon, an organosilicon polymer comprising siloxane units having hydrogen atoms bonded to the silicon, a catalyst, for example a tin compound, and a finely divided filler comprising silica which has been treated to become hydrophobic.

A variant described in U.S. Pat. No. 3,923,705 consisted in providing compositions comprising polydiorganosiloxanes bearing hydrogen atoms bonded to the silicon available for a condensation reaction with polydiorganosiloxanes bearing hydroxyl groups bonded to the silicon (silanols) in the presence of a platinum catalyst. This reaction thus makes it possible to construct the network while producing hydrogen gas necessary for the formation of a silicone foam. In this type of formulation, the formation of gas is proportional to the rate of crosslinking and consequently the density of the foams obtained is difficult to control, thus explaining the difficulties in obtaining low-density foams by this technique.

According to another variant described in U.S. Pat. No. 4,189,545, silicone foams are prepared from a composition comprising water, a polydiorganosiloxane bearing vinyl groups bonded to the silicon, a polydiorganosiloxane containing hydrogen atoms bonded to the silicon and borne by units in the chain and not exclusively at the chain end, in order to be able to act as a crosslinking agent. The water reacts with the polysiloxane comprising hydride functions, thus producing hydrogen gas and a silanol. The silanol then reacts with the polydiorganosiloxane comprising hydride functions via a condensation reaction, thus generating a second molecule of hydrogen gas, while another polydiorganosiloxane bearing vinyl groups bonded to the silicon will simultaneously react, via an addition reaction, with another polydiorganosiloxane comprising a hydride function, thus participating in the construction of the network of the silicone foam.

In U.S. Pat. No. 4,590,222, silicone foams are prepared from a composition comprising a polydiorganosiloxane, a resin, a platinum-based catalyst, an organohydro-siloxane, a polyorganosiloxane bearing hydroxyl groups on the chain-end units, a filler and an organic alcohol.

When ranges are used herein for physical properties, such as molecular weight, or chemical properties, such as chemical formulae, all combinations, and subcombinations of ranges for specific embodiments therein are intended to be included.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A pre-foam mix, comprising:
(i) at least one foamable silicone pre-polymer; and
(ii) one blowing agent comprising at least one non-fluorinated blowing agent.

2. A foam, comprising at least one partially-cured silicone polymer and at least one non-fluorinated blowing agent.

3. A foam, comprising at least one partially-cured silicone polymer, wherein said foam is prepared using at least one non-fluorinated blowing agent.

4. A foam, comprising at least one substantially-cured silicone polymer and at least one non-fluorinated blowing agent.

5. A foam, comprising at least one substantially-cured silicone polymer, wherein said foam is prepared using at least one non-fluorinated blowing agent.

6. The pre-foam mix as recited in claim 1, wherein said non-fluorinated blowing agent is selected from methylal, ethylal, propylal, butylal, tetraoxaundecane, 1,3-dioxolane, 2-ethylhexylal, glycerol formal, dimethyl acetal, fructone, water, methyl formate, unsymmetrical methyl ethyl acetal of formaldehyde, cyclopentane, n-pentane, isopentane, blends thereof, mixtures thereof, and combinations thereof.

7. The pre-foam mix as recited in claim 6, wherein, the non-fluorinated blowing agent further comprises a polyol such as a diol or a triol or tetrol.

8. The pre-foam mix as recited in claim 1 wherein said blowing agent comprises at least one fluorinated blowing agent selected from HFO-1233-zd-E, HFC-245fa, HFC-365mfc, HFO-1336 mzz-Z, HFC-227ea, blends thereof, mixtures thereof, and combinations thereof.

9. The foam as recited in claim 2, wherein said foam is substantially close-celled.

10. The foam as recited in claim 2, wherein said foam is substantially open-celled.

11. The foam as recited in claim 2, wherein said foam is partially open-celled and partially close-celled.

12. The pre-foam mix as recited in claim 1, wherein said non-fluorinated blowing agent is used in the concentration ranging from 0.1% to about 20% by weight of the blowing agent over the total weight of the pre-foam mix.

13. The pre-foam mix as recited in claim 1, wherein said at least one silicone pre-polymer or said at least one silicone polymer includes a Si—O—Si— backbone with organic methyl or phenyl groups attached to the silicon atoms (Me-Si or Ph-Si).

14. The pre-foam mix as recited in claim 1 further comprising a foaming agent.

15. A process for preparing a foam, comprising at least one foamable silicone polymer, said process comprising the steps of:
preparing a pre-foam mix, comprising:
(i) at least one foamable silicone pre-polymer; and
(ii) at least one blowing agent comprising at least one non-fluorinated blowing agent;
optionally mixing one or more additional silicone pre-polymers into the pre-foam mix;
removing at least a portion of said at least one blowing agent; and
partially or substantially fully curing said at least one foamable silicone pre-polymer or said product of optionally mixing one or more additional silicone pre-polymers.

16. A foam comprising at least one partially-cured silicone polymer and at least one non-fluorinated blowing agent prepared by the process as recited in claim 15.

17. A foam comprising at least one substantially-cured silicone polymer and at least one non-fluorinated blowing agent prepared by the process as recited in claim 15.

18. The process as recited in claim 15, wherein said non-fluorinated blowing agent is selected from methylal, ethylal, propylal, butylal, tetraoxaundecane, 1,3-dioxolane, 2-ethylhexylal, glycerol formal, unsymmetrical methyl ethyl acetal of formaldehyde, dimethyl acetal, fructone, water, methyl formate, cyclopentane, n-pentane, isopentane, blends thereof, mixtures thereof, and combinations thereof.

19. The process as recited in claim 15, wherein the non-fluorinated blowing agent further comprises a polyol such as a diol or a triol or tetrol.

20. The process as recited in claim 15, wherein said blowing agent comprises at least one fluorinated blowing agent selected from HFO-1233-zd-E, HFC-245fa, HFC-365mfc, HFO-1336 mzz-Z, HFC-227ea, blends thereof, mixtures thereof, and combinations thereof.

21. The foam made by the process of claim 15, wherein said foam is substantially close-celled.

22. The foam made by the process of claim 15, wherein said foam is substantially open-celled.

23. The foam made by the process of claim 15, wherein said foam is substantially close-celled and substantially open-celled, or hybrid.

24. The foam made by the process of claim 15, wherein said non-fluorinated blowing agent is used in a concentration ranging from 0.1% to about 20% by weight of the blowing agent over the total weight of the pre-foam mix.

25. The process as recited in claim 15, wherein said at least one silicone pre-polymer or said at least one silicone polymer includes a Si—O—Si— backbone with organic methyl or phenyl groups attached to the silicon atoms (Me-Si or Ph-Si).

26. The process as recited in claim 15, further comprising a foaming agent.

27. A method for insulating an exterior surface of a building comprising, spraying the exterior surface of the building with a mixture of silicone pre-polymer and a blowing agent, to produce a silicone foam, wherein said silicone foam is prepared by curing the silicone pre-polymer, and optionally at least one surfactant, wherein said silicone foam has an open-cell structure, a close-cell structure, or a hybrid-structure, and wherein said open cell structure comprises cells which are essentially open, but also includes some randomly occurring, solid cell walls.

28. The method as recited in claim 27, wherein said silicone foam has a foam density of between 50 and 350 kg/m³, and has a cell size of between 0.03 μm and 1.5 μm, so that said silicone foam acts as a water and air barrier, while also being water vapor permeable.

29. The method of claim 27, wherein said foam is prepared by reacting a mixture of said A Component with said B Component at a weight ratio of from 0.5 to 5:1, wherein Component A is one type of silicone pre-polymer and Component B is another type of silicone pre-polymer.

30. The method of claim 27, wherein said surfactant is a mixture of an open-cell promoting surfactant and a closed-cell promoting surfactant.

31. The method of claim 27, wherein said silicone foam is formed by a combination of surfactants that results in a surfactant interaction which produces both completely open and at least partially open, cell walls.

32. The method of claim 27, wherein the open cell content of the silicone foams is greater than 95%, by number.

33. The method of claim 27, wherein said B Component additionally comprises a flame retardant.

34. The method of claim 27, wherein said open cells are characterized as having a cell size in the range of from 0.1 μm to 1.0 μm.

35. The method of claim 27, wherein said open cells are characterized as having a cell size of 0.8±0.3 μm.

36. The method of claim 27, wherein said silicone foam is characterized as having an R value in the range of from 2 to 15 per inch of thickness.

37. The method as recited in claim 27, wherein said open cell silicone foam is used to insulate the exterior surface of a wall of said building, and a closed cell silicone foam is used to insulate the interior surface of said wall.

38. The method for insulating a building as claimed in claims 27-37, wherein said open cell polyurethane foam is applied to a sheathing material to provide a silicone foam layer on the sheathing material.

39. The method for insulating an exterior surface of a building as claimed in claim 37, further comprising covering said silicone foam with one or more of brick, wood, wood siding, wood composite siding, vinyl siding, and aluminum siding.

40. A method for insulating the exterior surface of a building, comprising:
spraying a mixture of silicone pre-polymers on to a sheathing material of the exterior surface of a building to produce a silicone foam layer on the sheathing material, wherein said foam is prepared by reacting a first silicone pre-polymer as an A component, and a second silicone pre-polymer as a B Component, wherein one or both of the A and B components comprise a non-fluorinated blowing agent and optionally at least one surfactant, and said silicone foam layer having an open-cell, close-cell, or hybrid structure, wherein said silicone foam has a foam density of between 50 and 350 kg/m³, and has a cell size of between 0.03 μm and 1.5 μm, so that said silicone foam layer acts as a water and air barrier, while also being water permeable; and
covering said open cell silicone foam layer with one or more of brick, wood, wood siding, wood composite siding, vinyl siding, or aluminum siding.
